(19) United States
(12) Patent Application Publication
(10) Pub. No.: US 2010/0234501 A1
(43) Pub. Date: Sep. 16, 2010

(54) POLYMER COMPOSITION WITH ENHANCED GAS BARRIER, ARTICLES AND METHODS

(75) Inventors: Sanjay Mehta, Spartanburg, SC (US); Mark Ryan Roodvoets, Duncan, SC (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.a.r.l., Wilmington, DE (US)

(21) Appl. No.: 12/280,283

(22) PCT Filed: Feb. 21, 2007
(86) PCT No.: PCT/US2007/004464

§ 371 Date: Sep. 4, 2008

Related U.S. Application Data
(60) Provisional application No. 60/777,931, filed on Mar. 1, 2006.

(51) Int. Cl. C08K 5/17; B29C 49/04; C08K 5/12; C08K 5/10; C08K 5/13; C08K 5/06; C08K 5/092

(52) U.S. Cl. 524/186; 264/572; 524/294; 524/314; 524/315; 524/343; 524/372; 524/375; 524/599

(57) ABSTRACT

The present invention relates to a thermoplastic polymer composition with enhanced gas barrier properties comprising a thermoplastic polymer, an antiplasticizer and a chain extender. Suitable antiplasticizers and suitable chain extenders are disclosed herein. Other embodiments of the present invention include a method to produce such a thermoplastic composition, an article comprising such a thermoplastic composition, and a method for making such an article.

This application claims the benefit of U.S. Provisional Application No. 60/777931, filed Mar. 1, 2006.

### FIELD OF THE INVENTION

This invention relates to thermoplastic compositions with enhanced gas barrier properties, methods for preparing such compositions, a method of making articles from such compositions, and articles made from such compositions. In particular, this invention relates to polyesters for use in applications such as bottles wherein such enhanced barrier to carbon dioxide and/or oxygen is desirable.

### BACKGROUND OF THE INVENTION

Polyethylene terephthalate and its copolyesters (hereinafter referred to collectively as “PET”) are widely used to make containers for carbonated soft drinks, juice, water, and the like due to their excellent combination of clarity, mechanical, and gas barrier properties. In spite of these desirable characteristics, insufficient gas barrier of PET to oxygen and carbon dioxide limits application of PET for smaller sized carbonated soft drink containers, as well as for packaging oxygen sensitive products, such as food, beer, juice, and tea products.

Numerous technologies have been developed to enhance the barrier of PET to small gas molecules. For example, external or internal coatings for enhancing the gas barrier of PET containers have been developed. The coating layer is normally a very high barrier layer, either inorganic or organic, and slows down the diffusion of gases. Implementation of this technology, however, requires coating equipment not normally utilized in the manufacture of packaged beverages and therefore requires increased capital investment. These coatings are prone to cracking during the expansion of the polymeric walls of the container when filled with carbonated liquids, and during use. Such cracks reduce the gas barrier effectiveness of the coating.

Multi-layered containers have also been developed with a layer of high barrier polymer, such as poly (m-xylylene adipamide), sandwiched between two or more PET layers. Implementation of this technology also requires substantial capital investment and delamination of the container layers impacts appearance, barrier, and mechanical performance of the containers.

PET has been modified or blended with other components to enhance the gas barrier of the PET. Examples include polyethylene naphthalate (PEN)/PET copolymers or blends, isophthalate (IPA) modified PET, PET blended with polyethylene isophthalate (PEI) or a polyamide, such as nylon, and PET modified with resorcinol based diols. These copolymers and blends require a high mole % of the higher gas barrier polymer to achieve a significant improve in gas barrier for the compositions. This results in a deterioration of the physical properties of containers made from such compositions.

Products sensitive to oxygen, such as foods, beverages and medicines, deteriorate and spoil in the presence of oxygen. To prevent oxygen ingress to the products, different oxygen scavenger technologies have been developed, all based on the use of a readily oxidizable polymer, the oxidation of which is catalyzed by a transition metal salt. Examples include a multi-layered, nylon based oxygen scavenger and an oxygen scavenger composition that can be blended with the PET resin and used for monolayer containers. However the multilayer containers have the same problems as mentioned above for passive barrier multilayer containers. The blending of two incompatible polymers cause haze which limits this technology to colored containers.

The addition of certain additives, known as antiplasticizers, to polymers can reduce the diffusion of gases through the polymer. U.S. Pat. No. 6,489,386 to Plotzker et al. discloses the use of antiplasticizers with the following chemical structures:

HO—Ar—COOR, HO—Ar—COOR₁COO—Ar—OH, HO—Ar—CONHR,

HO—Ar—CO—NHR₃—COO—Ar—OH, HO—Ar—CONHR₂NHCO—AR—OH

In the foregoing structures, Ar is selected from the group consisting of substituted or unsubstituted phenylene or naphthalene. R₁, R₂, and R₃ are selected from the group consisting from C₁ to C₆ alkyl groups, a phenyl group, and a naphthyl group.

U.S. Patent Application 2005/0221036 to Shi discloses the use of antiplasticizers which have a chemical structure OH—Ar—OH, wherein Ar is substituted or unsubstituted naphthalene.

Although the use of such antiplasticizers does enhance the gas barrier properties of the base polymer there is a concomitant degradation of the molecular weight of the base polymer. Lower molecular weight polymer makes containers with poor mechanical performance, such as creep, drop impact, and poor stress cracking resistance. This problem can be overcome by increasing the molecular weight of the base resin. However this increases the cost of the base resin, and in the case of PET, the higher melt viscosity requires a higher temperature for injection molding the preforms which increases the undesirable degradation products such as acetaldehyde.

Therefore a need in the art exists to enhance the gas barrier performance of polymers, especially PET, in a manner that does not increase the capital and operating cost of manufacturing containers, and without reducing the molecular weight of the polymer.

### SUMMARY OF THE INVENTION

In accordance with the present invention, it has been found that the addition of chain extenders to antiplasticizers in a thermoplastic composition solves the loss in molecular weight, surprisingly enhances the gas barrier properties of articles made from this composition, and in the case of PET, this composition reduces the residual acetaldehyde in the article. The present invention includes a thermoplastic composition comprising a thermoplastic polymer, an antiplasticizer and a chain extender. Other embodiments of the present invention include a method to produce such a thermoplastic composition, an article comprising such a thermoplastic composition, and a method for making such an article.

### DETAILED DESCRIPTION OF THE INVENTION

Generally, this invention can be characterized by a thermoplastic polymer composition with enhanced gas barrier, a method for enhancing the gas barrier of a thermoplastic polymer composition, articles comprising such a thermoplastic polymer composition, and a method for making such articles. As explained in more detail below, embodiments of this invention provide a polymer composition and articles made therewith which exhibit enhanced barrier to gases while maintaining physical properties.

The present invention can be characterized by a thermoplastic composition comprising a thermoplastic polymer, an antiplasticizer and a chain extender. The thermoplastic polymer can be any condensation homopolymer, copolymer (both random and block) and blends of such thermoplastic polymers. Most suitable thermoplastic polymers are polyester base polymers including homopolymers and copolymers. Among suitable polyester base polymers are those polymers which contain structural units derived from one or more organic diacids (or their corresponding esters) selected from the group consisting of terephthalic acid, isophthalic acid, naphthalene dicarboxylic acids, hydroxybenzoic acids, hydroxynaphthoic acids, cyclohexane dicarboxylic acids, succinic acid, glutaric acid, adipic acid, sebacic acid, 1,12-dodecane dioic acid and the derivatives thereof, such as, for example, the dimethyl, diethyl, or dipropyl esters or acid chlorides of the dicarboxylic acids and one or more diols selected from ethylene glycol, 1,3-propane diol, naphthalene glycol, 1,2-propanediol, 1,2-, 1,3-, and 1,4-cyclohexane dimethanol, diethylene glycol, hydroquinone, 1,3-butane diol, 1,5-pentane diol, 1,6-hexane diol, triethylene glycol, resorcinol, and longer chain diols and polyols which are the reaction products of diols or polyols with alkylene oxides. The polyester can be polyethylene terephthalate, polyethylene naphthalate, polyethylene isophthalate, copolymers of these polyesters, or blends of these polyesters.

The polyester base polymer can be polyethylene terephthalate (PET), which includes PET polymer which has been modified with from about 1 mole % up to about 10 mole % of isophthalate (IPA) units, from about 0.5 mole % to about 5 mole % diethylene glycol (DEG), and from 0.5 mole % to about 10 mole % 1,4-cyclohexane dimethanol. The mole % is based on the molar weight of PET. Such modified PET polymers are commercially available and used for many barrier applications such as films and containers. Suitable containers include but are not limited to bottles, drums, carafes, coolers, and the like.

In accordance with embodiments of this invention, antiplasticizers are small organic compounds that reduce the free volume of the polymer to which they are added. As known to those skilled in the art, the amount of free volume in polymers, such as PET copolymers, determines their barrier to gas molecules. Lower free volume, reduces the gas diffusion rate, resulting in a higher barrier to the transportation of gas molecules across one side of an article to the other.

The antiplasticizers can be selected from the group consisting of: monoesters of hydroxy benzoic acid or hydroxynaphthoic acid, or dihydroxy naphthalene, or diesters of naphthoic acid, or a mixture of two or more of these, represented by the formulas:

R₁O—Ar—OR₂, R₁OOC—Ar—COOR₂

HO—Ar—COOR, HO—Ar—COOR₁COO—Ar—OH, HO—Ar—CONHR,

HO—Ar—CO—NHR₃—COO—Ar—OH, and HO—Ar—CONHR₂NHCO—AR—OH.

In the foregoing structures, Ar is selected from the group consisting of substituted or unsubstituted phenylene or naphthalene, R₁, R₂, and R₃ are selected from the group consisting of hydrogen, C₁ to C₆ alkyl groups, a phenyl group, and a naphthyl group. A preferred antiplasticizer is dimethyl naphthalate.

A typical range of antiplasticizer is about 0.5 to about 10 weight % of the base polymer, more particularly a range of about 2.5 to 5 weight %. The lower limit is established by the degree of gas barrier enhancement required. The upper limit being established by the effect of the antiplasticizer on reducing the physical properties of the article made with the polymer composition.

Chain extenders have at least two functional groups capable of addition reactions with the terminal groups of the thermoplastic polymer. In the case of polyesters, the terminal groups are hydroxyl and carboxyl. The chain extender can be selected from bisanhydrides, bisoxazolines, bisepoxides or carbonyl bis caprolactams; more particularly a chain extender is selected from pyromellitic dianhydride, 1,3-phenylenebisoxazoline, 1,4-phenylenebisoxazoline (PBO) or bisphenol A diglycidyl ether. A preferred chain extender is carbonyl bis (1-caprolactam) (CBC) which reacts with the hydroxyl terminal groups. Chain extenders can be enhanced when used in combination with each other, such as PBO reacting with the carboxyl groups and CBC reacting with the hydroxyl groups.

A typical range of chain extender is about 0.05 to about 2 weight % of the base polymer, more particularly a range of about 0.5 to about 1 weight %. The lower limit is established by the amount of molecular weight loss due to the presence of the antiplasticizer, and the upper limit established by the final molecular weight required for the article that is being manufactured.

Another embodiment of the present invention is a method of unifoimly blending a thermoplastic polymer, an antiplasticizer and a chain extender.

Another embodiment of the present invention is a method of blending a thermoplastic polymer, an antiplasticizer and a chain extender to form a resin, extruding said resin to form a preform, and stretch blow molding said preform into a container.

Yet another embodiment of the present invention is a method of blending a thermoplastic polymer, an antiplasticizer and a chain extender to form a resin, and extruding said resin to form a thermoplastic polymer article.

And yet another embodiment of the present invention is directed to an article such as a container, sheet or film having a blend of thermoplastic polymer, an antiplasticizer and a chain extender.

Particular embodiments of this invention provide polyesters, such as PET, with enhanced barrier to carbon dioxide. This makes certain embodiments of this invention particularly suited for carbonated drink containers, without a loss of physical properties but with lower levels of acetaldehyde.

### Test Methods

1. Intrinsic Viscosity (IV)
i) IV of the polyester resins is measured according to ASTM D4603-96
ii) Intrinsic viscosity (IV) is determined by dissolving 0.2 grams of the polymer with 20 milliliters of dichloroacetic acid (DCA) at a temperature of 76.5° C. for 40 minutes. The solution is cooled and placed in an Ubbelhode viscometer in a constant temperature bath at 25° C. for 30 minutes prior to the measurement of the drop time, which is compared to that of the pure DCA to determine the relative viscosity (RV). RV is converted to IV using the ISO certificated equation: IV=[(RV−1)×0.6907]+0.0631.

2. Acetaldehyde (AA)
i) The residual AA of amorphous and solid-stated resin, and preforms and bottles, is measured in accordance with ASTM F2013-01
ii) A representative sample of the polyester is cryogenically ground (using liquid nitrogen) in a Wiley Mill grinder such that the polymer passes through a number 10 mesh sieve but collects on a 25 mesh sieve. A weighed portion, 360 mg, is placed in a 17 ml vial and sealed and then heated at 150° C. for 30 min., in this closed system to release the acetaldehyde. The vial is cooled and the acetaldehyde content of the headspace is then analyzed by removing 0.5 ml and injecting this head-space gas into a gas chromatography (Hewlett Packard 5890). The AA peak height, compared to a standard, is measured and the AA in the polymer sample reported in parts per million acetaldehyde.
2. Carbon Dioxide Permeability of Films

Carbon dioxide permeability of films was measured using a MOCON Perinatran—C, model 4/41. Tests were conducted at 23° C. and 0% RH. Prior to testing, the film samples were nitrogen conditioned for 25 hrs. After the conditioning period, testing was started using a CO₂ flow rate of 20 seem (standard cubic centimeters per minute) and N₂ flow rate of 10 sccm. The sample area tested was 50 cm². The CO₂ permeation rate of the sample was measured for 45 minutes and reported as cm³/m².atm.day. The system automatically corrected the transmission rate value to atmospheric barometric pressure of 760 mm Hg. Once a steady state (equilibrium) was obtained, testing was complete. The sample thickness was measured. The carbon dioxide permeability was then reported as cm³.cm/m².atm.day.

3. Haze and Color

The haze of the preform and bottle walls was measured with a Hunter Lab ColorQuest II instrument. D65 illuminant was used with a CIE 1964 10° standard observer. The haze is defined as the percent of the CIE Y diffuse transmittance to the CIE Y total transmission. The color of the preform and bottle walls was measured with the same instrument and is reported using the CIELAB color scale, L* is a measure of brightness, a* is a measure of redness (+) or greenness (−) and b* is a measure of yellowness (+) or blueness (−).

### Examples

Unless otherwise stated, the base PET bottle resin was a commercial resin having an IV of 0.84, an IPA content of 2.8 mole % and a DEG content of 2.7 mole %. Unless otherwise stated, the additives, antiplasticizers and chain extenders, were dried at 50-60° C. in an oven prior to being dry mixed with the base polyester resin, which had been dried at 140-160° C. for at least 12 hours.

Unless otherwise noted, preforms were prepared on a single cavity Arburg injection molding machine with a weight of 24.5 grams. These preforms were stretch blow molded in a Sidel, model SBO1, machine to give 500 ml bottles with straight walls. The carbon dioxide permeability, haze and color of the bottles were measured on sections of the bottle sidewall. The haze and color of the preforms was measured on the wall of the preform that had been sliced longitudinally.

The barrier improvement factor (BIF) is the ratio of the CO₂ permeability of the base PET resin (i.e. without additives) to that of an example (with additives).

### Example 1

A range of compounds were evaluated as potential antiplasticizers at a loading of 3.5 weight % based on the weight of the PET bottle resin. The IV of the preform, b*, haze and BIF of bottles from the trials were measured and the results set forth in Table 1.

TABLE 1

| | Preform | Preform | Bottle | |
|---|---|---|---|---|
| Compound | IV | b* | Haze, % | BIF |
| None | 0.792 | 1.6 | 2.2 | 1.00 |
| Methyl 4-hydroxy benzoate | 0.626 | 1.4 | 2.6 | 1.50 |
| p-hydroxy benzoic acid | 0.422 | 1.2 | 5.8 | 1.45 |
| 1,3,5 trihydroxy benzene | n.m. | 4.2 | 4.6 | 2.00 |
| 1,3-dihydroxy naphthalene | 0.662 | 10 | 12.3 | 1.90 |
| Dimethyl naphthalate | 0.699 | 0.8 | 3.4 | 1.41 |
| 2-hydroxy-2-phenyl acetophenone | 0.533 | 1.2 | 14.6 | 1.62 |
| Anthracene | 0.780 | 5.9 | 16 | 1.20 |
| Dimethyl 4,4′-biphenyl | 0.730 | 2.7 | 18.8 | 1.25 |
| dicarboxylate | | | | |

n.m.—not measured

All compounds giving a BIF of 1.4 or greater had a greater IV loss during injection molding than the control, and many of these also gave an unacceptable color (yellowness) and/or haze to the bottle.

### Example 2

From these compounds, methyl 4-hydroxy benzoate (MHB), dimethyl naphthalate (DMN) and 1,3-dihydroxy naphthalene (DHN) were chosen to investigate the influence of chain extenders. Carbonyl bis caprolactam (CBC), purchased from DSM as Allico®-CBC, was chosen as the chain extender. Bottles were prepared from these antiplasticizers with and without dried CBC added at a 0.5 weight % level, based on the PET bottle resin. The measurements of the preforms and bottle sidewall are set forth in Table 2 below.

TABLE 2

| | | Preform | Preform | Preform AA, | |
|---|---|---|---|---|---|
| Compound | CBC, wt-% | IV | b* | ppm | BIF |
| None | 0 | 0.82 | 2.2 | 4.5 | 1.00 |
| DMN | 0 | 0.76 | 4.0 | 4.5 | 1.41 |
| DMN | 0.5 | 0.88 | 5.8 | 2.7 | 1.81 |
| MHB | 0 | 0.70 | 5.0 | 2.9 | 1.84 |
| MHB | 0.5 | 0.73 | 6.7 | 2.3 | 2.11 |
| DHN | 0 | 0.65 | 20.1 | 0.5 | 1.97 |
| DHN | 0.5 | 0.66 | 21.6 | 0.3 | 2.25 |

At a level of 0.5 weight %, CBC was effective in raising the preform IV above that of the control, and surprisingly the chain extender increased the BIF for all antiplasticizers. The reduction in preform AA was also unexpected.

### Example 3

In order to quantify the effect of the chain extender alone on the BIF, CBC was used at 2 levels with a 0.78 IV base polymer (no antiplasticizer). The measurements of the preforms and bottle sidewall are set forth in Table 3 below.

TABLE 3

| | | | Preform AA, | |
|---|---|---|---|---|
| CBC, wt-% | Preform IV | Preform b* | ppm | BIF |
| 0.0 | 0.76 | 1.50 | 7.7 | 1.00 |
| 0.3 | 0.80 | 8.41 | 6.3 | 1.04 |
| 0.5 | 0.87 | 9.39 | 5.4 | 1.20 |

It would appear that at an addition level of 0.5 weight %, CBC acts as an antiplasticizer (increase in BIF) as well as a chain extender and AA scavenger.

### Example 4

Another trial was conducted using 3.5 weight % DMN (based on weight of the polymer) with CBC and a different chain extender CESA®-9930C, which is a master batch of a low molecular weight epoxy grafted acrylic polymer in PET, supplied by Clariant.

The 24.5 grams preforms were prepared on a Husky eight cavity injection molding machine, and the dried additives were fed by a K-Tron feeder to the throat on the extruder. The measurements of the preforms and bottle sidewall are set forth in Table 4 below.

TABLE 4

| | Chain | Preform | Preform AA. | Bottle | |
|---|---|---|---|---|---|
| DMN, wt-% | Extender, wt-% | IV | ppm | Haze, % | BIF |
| none | none | 0.82 | 4.8 | 1.4 | 1.00 |
| 3.5 | none | 0.76 | 3.0 | 1.9 | 1.45 |
| 3.5 | CBC, 0.3 | 0.80 | 2.9 | 2.6 | 1.63 |
| 3.5 | CBC, 0.5 | 0.82 | 2.9 | 1.8 | 1.67 |
| 3.5 | CESA, 0.3 | 0.77 | 3.3 | 13.6 | 1.44 |

These results show that the loss of IV when DMN is used an antiplasticizer can be mitigated by using a chain extender and use of the chain extender also gives additional improvement in gas barrier, haze, and preform AA.

Thus it is apparent that there has been provided in accordance with the invention, thermoplastic compositions, a method for preparing such compositions, articles made from such compositions and a method of making such articles that fully satisfies the objects, aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. A thermoplastic composition comprising: a thermoplastic polymer, an antiplasticizer, and a chain extender.

2. The composition of claim 1 wherein said thermoplastic polymer is a polyester or copolyester.

3. The composition of claim 2 wherein said thermoplastic polymer is selected from the group consisting of polyethylene terephthalate, polyethylene naphthalate, polyethylene isophthalate, copolymers of polyethylene terephthalate, copolymers of polyethylene naphthalate, and copolymers of polyethylene isophthalate.

4. The composition of claim 3 wherein said thermoplastic polymer is a copolymer of polyethylene terephthalate.

5. The composition of claim 1 wherein said antiplasticizer is selected from the group consisting of:
R₁O—Ar—OR₂, R₁OOC—Ar—COOR₂
HO—Ar—COOR, HO—Ar—COOR₁COO—Ar—OH, HO—Ar—CONHR,
HO—Ar—CO—NHR₃—COO—Ar—OH, and HO—Ar—CONHR₂NHCO—AR—OH;
wherein Ar is selected from the group consisting of substituted phenylene, unsubstituted phenylene, substituted naphthalene, and unsubstituted naphthalene; R₁, R₂, and R₃ are selected from the group consisting of hydrogen, C₁ to C₆ alkyl groups, a phenyl group, and a naphthyl group.

6. The composition of claim 5 wherein said antiplasticizer is dimethyl naphthalate.

7. The composition of claim 1 wherein said chain extender is selected from the group consisting of bisanhydrides, bisoxazolines, bisepoxides and carbonyl bis caprolactams.

8. The composition of claim 7 wherein said chain extender is carbonyl bis caprolactam.

9. A composition comprising a polyester or copolyester, dimethyl naphthalate and carbonyl his caprolactam.

10. The composition of claim 1 wherein said antiplasticizer is present in an amount of about 1 to about 10 weight % of the total composition.

11. The composition of claim 1 wherein the chain extender is present in an amount of about 0.02 to about 2 weight % of the total composition

12. A method of reducing gas permeability of shaped thermoplastic polymer articles wherein said thermoplastic polymer is the composition of claim 1 comprising:
a) incorporating into said thermoplastic polymer said antiplasticizer and said chain extender,
b) heating the mixture to melt the said thermoplastic polymer, and
c) forming the shaped thermoplastic polymer article.

13. A shaped thermoplastic polymer article comprising the composition of claim 1.

14. A method of making a shaped thermoplastic polymer container comprising the thermoplastic composition of claim 1 comprising:
a) blending said thermoplastic polymer, said antiplasticizer and said chain extender to form a resin;
b) extruding said resin to form a perform; and
c) stretch blow molding said preform into the shaped thermoplastic polymer container.

15. A method of making a thermoplastic polymer article comprising the thermoplastic composition of claim 1 comprising:
a) blending said thermoplastic polymer, said antiplasticizer and said chain extender to form a resin; and
b) extruding said resin to form the thermoplastic polymer article.
